(19) United States
(12) Patent Application Publication
(10) Pub. No.: US 2012/0188291 A1
(43) Pub. Date: Jul. 26, 2012

(54) IMAGE DISPLAY APPARATUS AND CONTROL METHOD THEREOF

(75) Inventor: Koji Kobayashi, Yokohama-shi (JP)

(73) Assignee: CANON KABUSHIKI KAISHA, Tokyo (JP)

(21) Appl. No.: 13/339,918

(22) Filed: Dec. 29, 2011

(30) Foreign Application Priority Data
Jan. 26, 2011 (JP) 2011-014412

(51) Int. Cl. G09G 5/02

(52) U.S. Cl. 345/690

(57) ABSTRACT

A single pixel is formed from a plurality of pixel circuits including a first pixel circuit that applies an electric signal for driving a first electro-optic device to the first electro-optic device and a second pixel circuit that applies an electric signal for driving a second electro-optic device having a shorter persistence time than the first electro-optic device to the second electro-optic device. The first and second pixel circuits output the respective electric signals such that a center of gravity of a waveform of the electric signal applied to the second electro-optic device is temporally delayed relative to a center of gravity of a waveform of the electric signal applied to the first electro-optic device.

### BACKGROUND OF THE INVENTION

1. Field of the Invention

The present invention relates to an active-matrix type image display apparatus, and a control method thereof.

2. Description of the Related Art

A liquid crystal display apparatus (LCD), a plasma display apparatus (PDP), an electroluminescence display apparatus (ELD), a field emission display apparatus (FED), and so on are available as flat panel displays (FPDs). Of these apparatuses, an ELD is self-emitting and exhibits low view angle dependence and high-speed responsiveness. Therefore, a favorable moving image quality is realized easily with an ELD. Further, among ELDs, an active-matrix driven display apparatus can exhibit a high definition easily while reducing a peak current flowing to a display element, and therefore a long-lived, highly reliable display apparatus can be realized.

In an active-matrix driven hold-type display apparatus, a phenomenon known as hold blur occurs such that a video appears blurred during moving image display. Japanese Patent Application Laid-open No. 2001-60076 discloses an image display apparatus in which a time-averaged display brightness of an organic EL element provided therein is adjusted easily by varying a proportion of a light emission time (a duty) within a single frame.

In a self-emitting display apparatus such as an ELD or an FED, both fluorescent material and phosphorescent material may be used as a material of a light emitter. These materials have different features. For example, fluorescent material has a short persistence time, while phosphorescent material has a long persistence time but a high light emission efficiency. When fluorescent material and phosphorescent material can be selected freely for each color or each pixel, an improvement in design freedom can be obtained, and increases in a brightness and a color gamut of a color display apparatus can be expected. However, since fluorescent material and phosphorescent material have different persistence characteristics and so on, it is more typical conventionally to form all of the pixels on a display panel on which a plurality of pixels are arranged from a similar material, i.e. fluorescent material alone or phosphorescent material alone.

We have found, through investigations, that when a video that moves at high speed is displayed on a high definition display apparatus that uses light emitters having different persistence characteristics for each color, a phenomenon known as “color balance degradation” occurs due to the differences in the persistence characteristics of the light emitters, causing a visual disturbance. The color balance degradation phenomenon will be described in detail below.

FIG. 2 shows a light emission waveform of a short persistence light emitter and a light emission waveform of a long persistence light emitter in a case where a rectangular current waveform is applied. An abscissa shows time, an ordinate of the current waveform shows a current value, and an ordinate of the light emission waveforms shows a light emission intensity. As shown in the drawing, the light emission waveform of the short persistence light emitter is substantially identical in shape to the current waveform, whereas the light emission waveform of the long persistence light emitter is shaped such that a rise and a fall of light emission have predetermined time constants. Hence, at the rise of light emission, a color of the short persistence light emitter (a short persistence color hereafter) is relatively intense, while at the fall of light emission, a color of the long persistence light emitter (a long persistence color hereafter) is relatively intense, and as a result, a visual disturbance occurs. Here, a phenomenon occurring at the rise time of light emission will be referred to as a “coloring delay”, and a phenomenon occurring at the fall time of light emission will be referred to as a “decoloring delay”. These phenomena are particularly evident when a person follows a video that moves at high speed, resulting in the long persistence color appearing to move at a delay.

### SUMMARY OF THE INVENTION

The present invention has been designed in consideration of the problems described above, and an object thereof is to provide a technique used in a self-emitting image display apparatus to realize a high quality color display by suppressing color balance degradation occurring due to differences in a persistence time between pixels.

The present invention in its first aspect provides an active-matrix type self-emitting image display apparatus including: a plurality of scanning lines; a plurality of data lines; and a plurality of pixel circuits disposed in respective intersecting portions between the scanning lines and the data lines, wherein a single pixel is formed from a plurality of pixel circuits including a first pixel circuit that applies an electric signal for driving a first electro-optic device to the first electro-optic device and a second pixel circuit that applies an electric signal for driving a second electro-optic device having a shorter persistence time than the first electro-optic device to the second electro-optic device, and the first and second pixel circuits output the respective electric signals such that a center of gravity of a waveform of the electric signal applied to the second electro-optic device is temporally delayed relative to a center of gravity of a waveform of the electric signal applied to the first electro-optic device.

The present invention in its second aspect provides a control method for an active-matrix type self-emitting image display apparatus and includes a plurality of pixel circuits disposed in respective intersecting portions between a plurality of scanning lines and a plurality of data lines, the method including the steps of: applying an electric signal for driving a first electro-optic device to the first electro-optic device from a first pixel circuit; and applying an electric signal for driving a second electro-optic device having a shorter persistence time than the first electro-optic device to the second electro-optic device from a second pixel circuit that forms a single pixel together with the first pixel circuit, wherein the first and second pixel circuits output the respective electric signals such that a center of gravity of a waveform of the electric signal applied to the second electro-optic device is temporally delayed relative to a center of gravity of a waveform of the electric signal applied to the first electro-optic device.

According to the present invention, color balance degradation occurring due to differences in a persistence time between pixels can be suppressed in a self-emitting image display apparatus, and as a result, a high quality color display can be realized.

Further features of the present invention will become apparent from the following description of exemplary embodiments with reference to the attached drawings.

### BRIEF DESCRIPTION OF THE DRAWINGS

FIG. 1 is a view illustrating a relationship between a current waveform and a light emission waveform according to a third embodiment of the present invention;

FIG. 2 is a view illustrating a relationship between a current waveform and a light emission waveform according to a conventional image display apparatus;

FIG. 3 is an example of a pixel circuit of an image display apparatus according to a first embodiment of the present invention;

FIG. 4 is a view showing an overall configuration of an image display apparatus according to the first and third embodiments of the present invention;

FIG. 5 is a view illustrating a relationship between a current waveform and a light emission waveform according to the first embodiment of the present invention;

FIG. 6 is an example of a pixel circuit of an image display apparatus according to a second embodiment of the present invention;

FIG. 7 is an example of an overall configuration of the image display apparatus according to the second embodiment of the present invention;

FIG. 8 is a view illustrating a relationship between a current waveform and a light emission waveform according to the second embodiment of the present invention;

FIG. 9 is a view illustrating a problem in the image display apparatus according to the second embodiment of the present invention;

FIG. 10 is an example of a pixel circuit of the image display apparatus according to the third embodiment of the present invention;

FIG. 11 is a modified example of the pixel circuit of the image display apparatus according to the third embodiment of the present invention;

FIG. 12 is a modified example of the overall configuration of the image display apparatus according to the third embodiment of the present invention;

FIG. 13 shows a pixel circuit of a conventional image display apparatus; and

FIG. 14 is a timing chart relating to a conventional image display apparatus.

### DESCRIPTION OF THE EMBODIMENTS

The present invention relates to an image display apparatus that uses a plurality of electro-optic devices having different persistence times as light emitting elements, and more particularly to a technique for controlling rise/fall speeds and timings of an electric signal that drives each element in order to suppress color balance degradation caused by the differences in the persistence time. The present invention can be applied favorably to an image display apparatus in which the plurality of electro-optic devices are driven using an active-matrix system. Here, an electro-optic device is a self-emitting device, a light emission intensity (a brightness) of which is controlled by an electric signal (a current signal or a voltage signal). For example, the electro-optic device may be an “organic light emitting diode (OLED)”, a “light emitting element constituted by an electron emitting element (a cold cathode element) and an electron beam excited fluorescent substance”, and so on. The persistence time is represented as a time constant of light emission response to the corresponding electric signal.

Embodiments of the present invention will be described below using an ELD having an OLED as a light emitting element as an example.

### Reference Example: Description of Related Art

First, to facilitate understanding of the present invention, a conventional example (a first embodiment of Japanese Patent Application Laid-open No. 2001-60076) relating to an active-matrix driven display apparatus serving as a precursor of the present invention will be described.

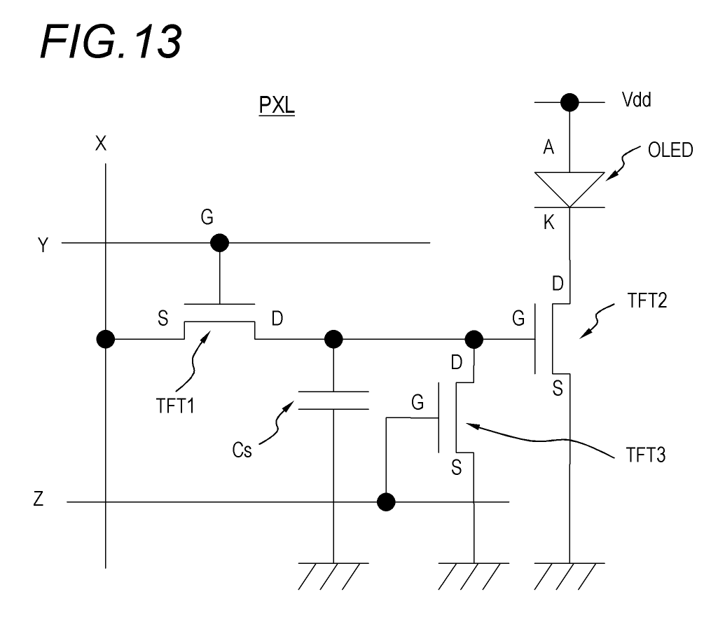

FIG. 13 is an equivalent circuit diagram corresponding to a single pixel of the reference example. As shown in the drawing, in this image display apparatus, a scanning line Y for selecting a pixel circuit PXL in a predetermined scanning cycle (a frame) and a data line X for applying gradation information required to drive the pixel circuit PXL are arranged in matrix form. The pixel circuit PXL disposed at an intersecting portion between the scanning line Y and the data line X includes a light emitting element OLED, a TFT1 serving as a first active element, a TFT2 serving as a second active element, and a hold capacitor Cs. A brightness of the light emitting element OLED varies in accordance with a current amount supplied thereto. The TFT1 is a switch controlled by the scanning line Y, and when the TFT1 is ON, the gradation information supplied from the data line X is written to the hold capacitor Cs. The TFT2 is a transistor that controls an electric signal (a current amount in this example) supplied to the light emitting element OLED in accordance with the gradation information written to the hold capacitor Cs.

The gradation information is written to the pixel circuit PXL by applying an electric signal (a data potential Vdata) corresponding to the gradation information to the data line X in a condition where the scanning line Y is selected. The gradation information written to the pixel circuit PXL is held in the hold capacitor Cs even after the scanning line Y has been unselected, and therefore the light emitting element OLED can be kept illuminated at a brightness corresponding to the held gradation information.

Further, a TFT3 serving as a third active element is a switch (an extinction circuit) for controlling a light emission period of the light emitting element OLED. More specifically, the OLED can be extinguished by controlling a gate potential of the TFT2 in accordance with a control signal applied to a gate G of the TFT3. The control signal is applied to the TFT3 included in each pixel circuit PXL on the corresponding scanning line via a stop control line Z. When the TFT3 is switched ON in accordance with the control signal, the hold capacitor Cs is discharged such that a gate-source voltage Vgs of the TFT2 becomes 0 V, and thus a current flowing to the OLED can be blocked. The gates G of the TFT3 in all of the pixel circuits PXL disposed on the same scanning line are connected in common to an identical stop control line Z such that light emission stoppage control can be performed in stop control line Z units.

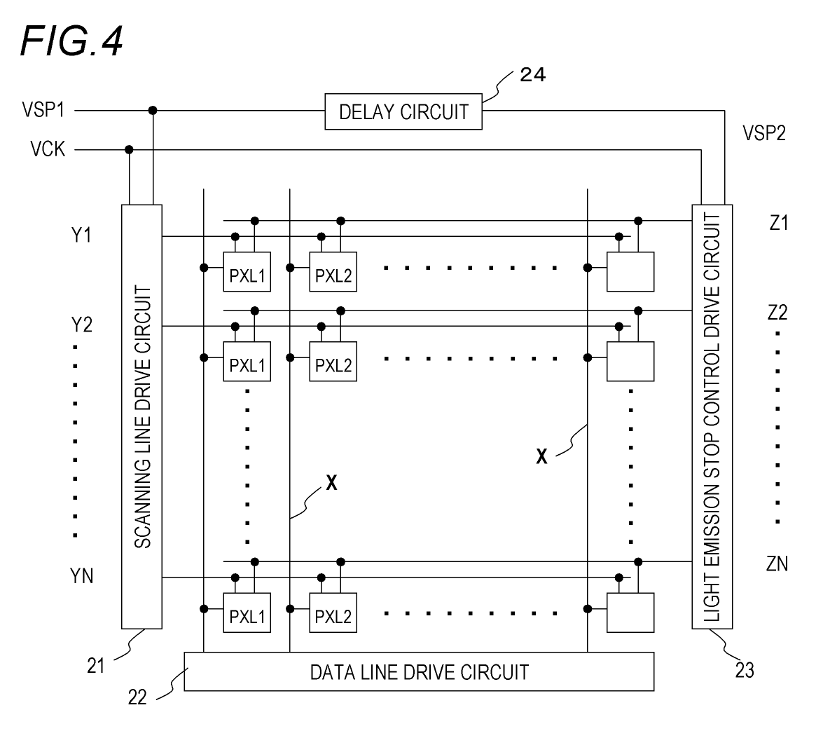

FIG. 4 is a circuit diagram showing an overall configuration of the image display apparatus shown in FIG. 13, in which the pixel circuits PXL are arranged in matrix form. As shown in the drawing, scanning lines Y1, Y2, . . . , YN are arranged in rows, and the data lines X are arranged in columns. The pixel circuit PXL is formed at the intersecting portion between each scanning line Y and the data line X. Further, stop control lines Z1, Z2, . . . , ZN are formed parallel to the scanning lines Y1, Y2, . . . , YN.

The scanning line Y is connected to a scanning line drive circuit 21. The scanning line drive circuit 21 includes a shift register, and by transferring a vertical start pulse VSP1 sequentially in synchronization with a vertical clock VCK, the scanning lines Y1, Y2, . . . , YN are selected in sequence within a single scanning cycle. The stop control lines Z, meanwhile, are connected to a stop control line drive circuit 23. This drive circuit 23 also includes a shift register, and by transferring a vertical start pulse VSP2 sequentially in synchronization with VCK, the control signal is output to the stop control lines Z. Note that a delay circuit 24 delays VSP2 relative to VSP1 by a predetermined time.

The data lines X are connected to a data line drive circuit 22. The data line drive circuit 22 outputs an electric signal corresponding to the gradation information to each data line X in synchronization with the line sequence scanning of the scanning lines Y. In this case, the data line drive circuit 22 performs so-called line sequence driving to supply the electric signal at once to the row of the selected pixel.

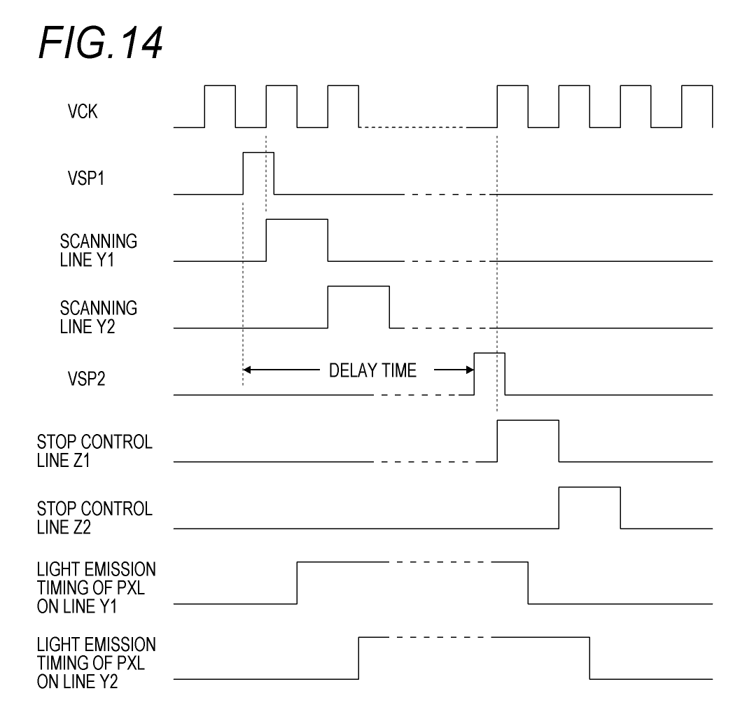

FIG. 14 is a timing chart provided to illustrate an operation of the image display apparatus shown in FIG. 4. First, the vertical start pulse VSP1 is input into the scanning line drive circuit 21 and the delay circuit 24. After receiving the input of VSP1, the scanning line drive circuit 21 selects the scanning lines Y1, Y2, . . . , YN sequentially in synchronization with the vertical clock VCK such that the gradation information is written into the pixel circuits PXL in scanning line units. The respective pixel circuits PXL then start to emit light at an intensity corresponding to the gradation information written therein. VSP1 is then delayed by the delay circuit 24 so as to be input into the stop control line drive circuit 23 as VSP2. After receiving VSP2, the stop control line drive circuit 23 selects the stop control lines Z1, Z2, . . . , ZN sequentially in synchronization with the vertical clock VCK, whereby light emission is stopped in scanning line units.

According to the configuration shown in FIGS. 4, 13, and 14, the respective pixel circuits PXL emit light from the point at which the gradation information is written to the point at which light emission is stopped by a light emission stop control signal, or in other words roughly for a delay time set by the delay circuit 24. When the delay time is set as τ and the time of a single scanning cycle (a single frame) is set as T, a time ratio during which the pixel emits light, or in other words a duty, is roughly τ/T.

### First Embodiment

A first embodiment of the present invention will be described in detail below, focusing on differences with the reference example described above.

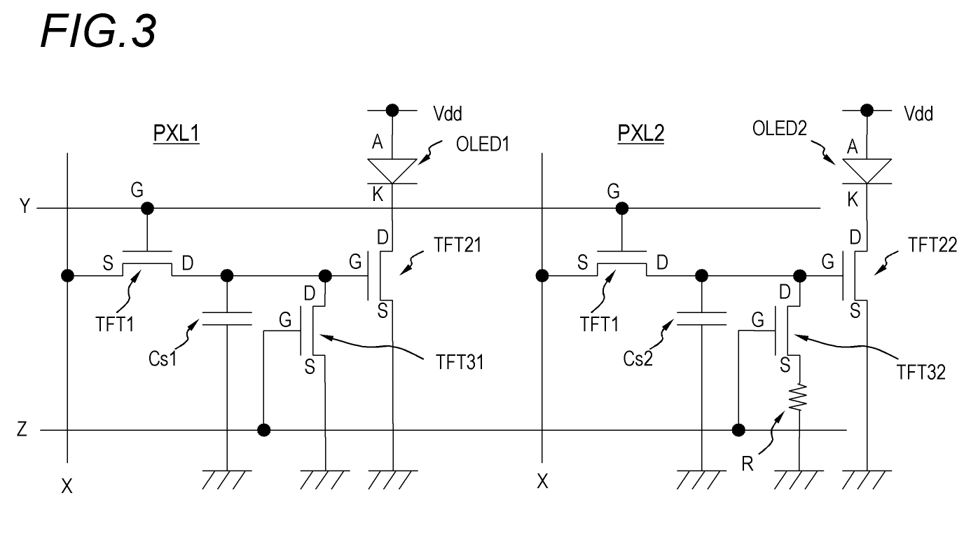

FIG. 3 is an example of an equivalent circuit diagram corresponding to two pixels, namely a left pixel and a right pixel, according to the first embodiment of the present invention. The left side shows a first pixel circuit (PXL1) of a long persistence color, having a long persistence light emitter OLED1 (a first electro-optic device) , and the right side shows a second pixel circuit (PXL2) of a short persistence color, having a short persistence light emitter OLED2 (a second electro-optic device). In a typical image display apparatus, a single point is expressed by pixel circuits in a plurality of primary colors (the three colors RGB, for example). The pixel circuits of the respective primary colors maybe referred to as “subpixels”, and a group of a plurality of subpixels may be referred to as a “pixel”. The respective pixel circuits shown in FIG. 3 correspond to subpixels.

A light emitting material of each primary color is selected appropriately from various types of fluorescent materials and phosphorescent materials, taking into account color purity, light emission efficiency, lifespan, color balance, and so on. In this embodiment, for example, a long persistence phosphorescent material is used as the light emitting material of the R (red) pixels, while a short persistence fluorescent material is used as the light emitting material of the G (green) pixels and B (blue) pixels. In FIG. 3, PXL1 denotes an R pixel and PXL2 denotes a G pixel. Although a B pixel is not shown, the B pixel has an identical circuit configuration to PXL2.

The pixel circuit has an identical basic configuration to the reference example, but differs therefrom in that the second pixel circuit PXL2 includes a resistor R disposed on a discharge path of a hold capacitor Cs2. In other words, in the short persistence second pixel circuit PXL2, the extinction circuit is constituted by the hold capacitor Cs2 and the resistor R. The resistor R is provided to adjust a difference in persistence time caused by a difference between persistence characteristics of the light emitters in accordance with a fall characteristic of the current waveform applied to the OLED, and acts to delay a discharge speed of Cs2, or in other words a speed at which a gate potential of a TFT22 is reduced.

A resistance of the resistor R should be set such that a time constant constituted by the hold capacitor Cs2 and the resistor R corresponds to a difference between persistence time constants of the two light emitters OLED1, OLED2. The resistor R may be formed by adjusting a gate width and a gate length of a TFT32 so that an ON resistance becomes greater than that of a TFT31, or may be formed using an appropriate resistive material. As noted above, other than the resistance times of the light emitters and the resistance value, the first embodiment is identical to the reference example.

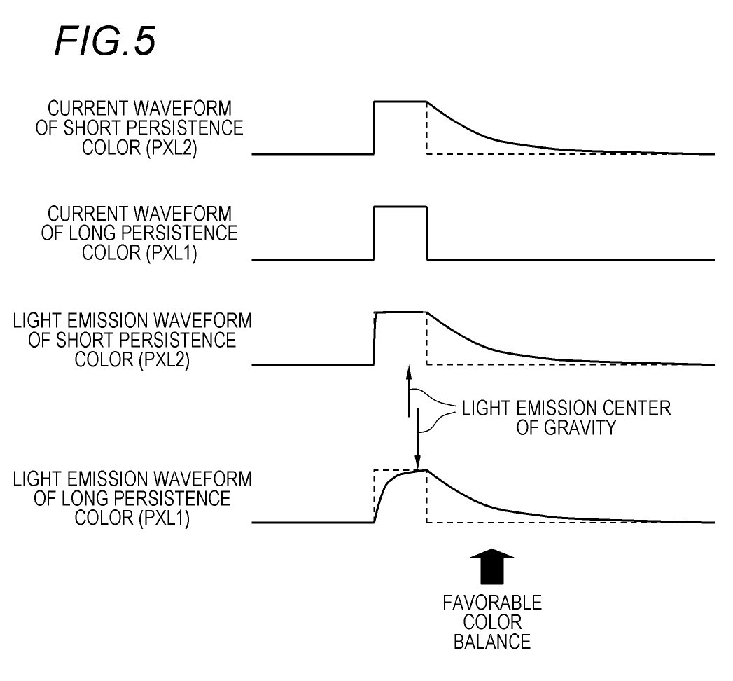

FIG. 5 is a timing chart illustrating an operation of the image display apparatus according to the first embodiment of the present invention, shown in FIG. 3. An uppermost section of FIG. 5 shows the current waveform of the short persistence color image pixel PXL2, a second section shows the current waveform of the long persistence color pixel circuit PXL1, the abscissa shows time, and the ordinate shows the current amount. Third and fourth sections show light emission waveforms of PXL2 and PXL1, respectively, while the abscissa shows time and the ordinate shows the light emission intensity.

In PXL1 and PXL2, respective start timings of the rise and the fall of a current signal are identical. However, a discharge time constant of the capacitance Cs2 in PXL2 is greater than a discharge time constant of a capacitance Cs1 in PXL1 by an amount corresponding to the resistor R, and therefore the gate potential of the driving transistor TFT22 of OLED2 decreases more gently than a gate potential of a driving transistor TFT21 of OLED1. Hence, as shown in FIG. 5, an attenuation speed of the current signal applied to OLED2 is lower than an attenuation speed of the current signal applied to OLED1. In other words, a fall time of the waveform of the current signal applied to OLED2 is longer than a fall time of the waveform of the current signal applied to OLED1. As a result, a center of gravity of the current waveform applied to OLED2 can be delayed temporally relative to a center of gravity of the current waveform applied to OLED1. Hence, the center of gravity of the current waveform means a center of time for integral of current in the current waveform.

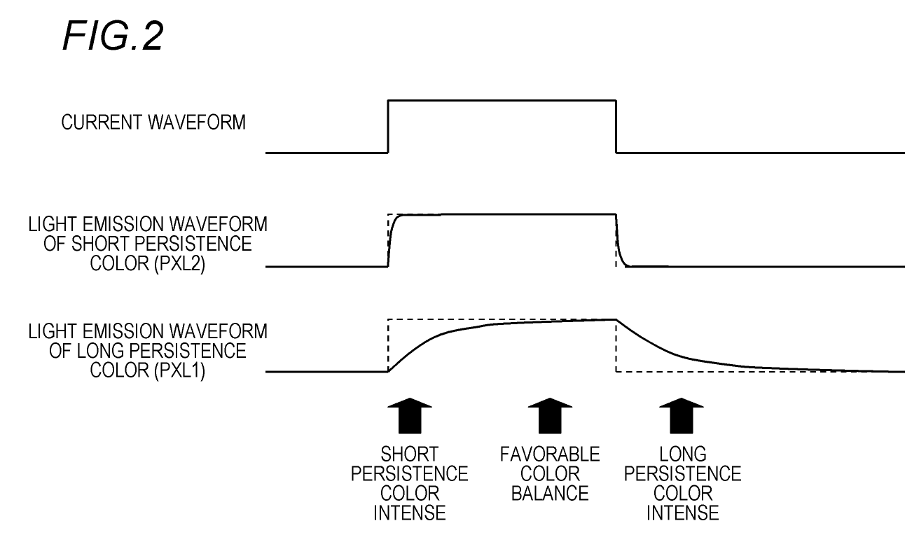

With the configuration described above, as shown in FIG. 5, a deviation between the centers of gravity of the respective light emission waveforms of the short persistence color and the long persistence color can be reduced in comparison with the related art (see FIG. 2), and therefore color balance degradation can be suppressed. In this embodiment in particular, the short persistence color pixel can be caused to emit light in accordance with the persistence in the long persistence color pixel, and therefore a decoloring delay can be suppressed effectively.

### Second Embodiment

In the first embodiment, as shown in FIG. 5, the falling waveforms of light emission can be aligned but the rising waveforms of light emission cannot be aligned. Therefore, the center of gravity of the light emission waveform of the long persistence color (PXL1) may be temporally delayed such that color balance degradation remains.

Hence, in a second embodiment of the present invention, a rise timing of the current waveform applied to the short persistence electro-optic device (OLED2) is delayed relative to a rise timing of the current waveform applied to the long persistence electro-optic device (OLED1). The second embodiment of the present invention will be described in detail below, focusing on differences with the first embodiment.

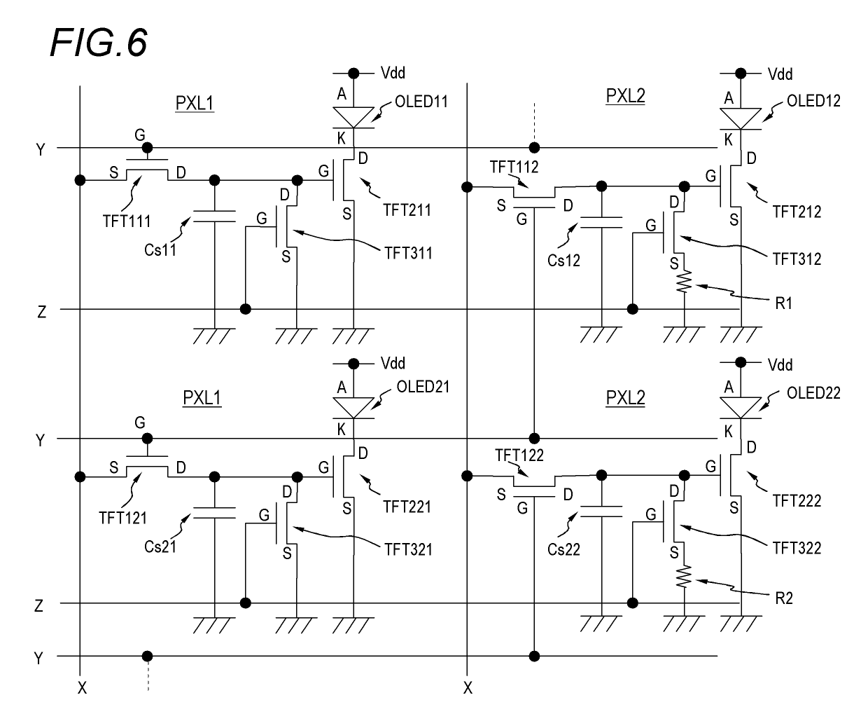

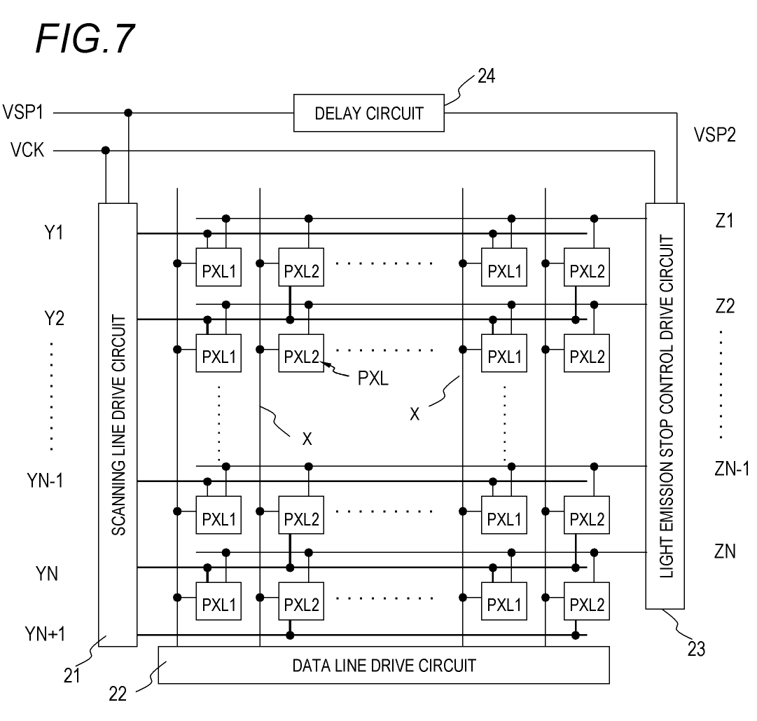

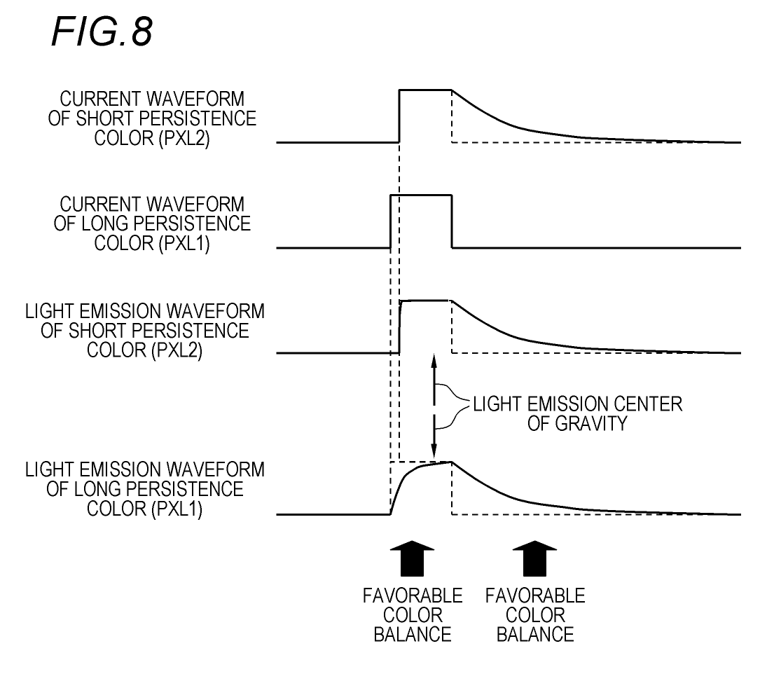

FIG. 6 is an example of an equivalent circuit diagram corresponding to four pixels, namely left, right, upper, and lower pixels, according to the second embodiment of the present invention, and FIG. 7 is an example of a circuit diagram showing an overall configuration of an image display apparatus in which the pixel circuits PXL shown in FIG. 6 are arranged in matrix form. As shown in the drawings, the second embodiment is identical to the first embodiment apart from a wiring method of the scanning lines Y and a TFT112 (or a TFT122). In the second embodiment, wiring is performed such that the long persistence color pixel circuit (PXL1), in which light emission rises late, starts to emit light earlier than the short persistence color pixel circuit (PXL2). More specifically, PXL1 is wired similarly to the first embodiment, whereas PXL2 is connected to the scanning line Y that is driven (selected) immediately after the scanning line Y to which PXL1 is connected. As a result, as shown in FIG. 8, the rise start timing of light emission in the short persistence color can be delayed by a single scanning row period. Note that gradation information deviating by a single row between PXL1 and PXL2 should be output from the data line drive circuit 22.

By delaying the rise timing of the current waveform applied to the second electro-optic device relative to the rise timing of the current waveform applied to the first electro-optic device in this manner, the difference between the centers of gravity of the light emission waveforms can be reduced either to zero or as far as possible, as shown in FIG. 8. As a result, color balance degradation can be suppressed even more effectively than in the first embodiment.

### Third Embodiment

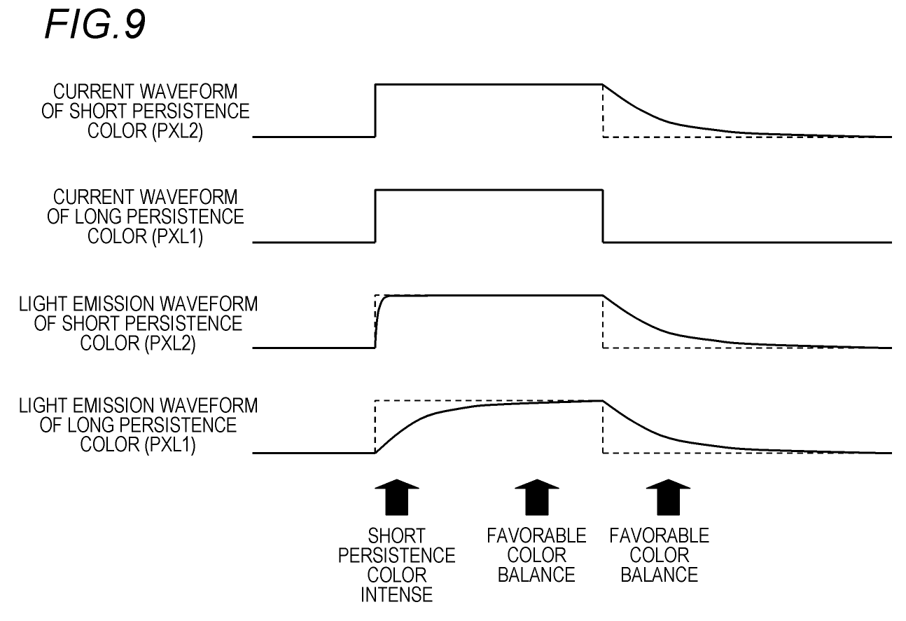

In the method used in the second embodiment, the rise timing can only be adjusted by a single scanning row period. Therefore, when the light emission period (the duty) is large, it is difficult to align the respective centers of gravity of the light emission waveforms of PXL1 and PXL2. Further, as shown in FIG. 9, a problem occurs in that during an initial period of the rise of light emission, the short persistence color increases in intensity, leading to color balance degradation (a coloring delay).

Hence, in the third embodiment of the present invention, an increase speed at which the current waveform applied to the short persistence electro-optic device (OLED2) rises is reduced relative to an increase speed at which the current waveform applied to the long persistence electro-optic device (OLED1) rises. In other words, the rise time of the waveform of the current signal applied to the short persistence electro-optic device (OLED2) is lengthened relative to the rise time of the waveform of the current signal applied to the long persistence electro-optic device (OLED1). The third embodiment of the present invention will be described in detail below, focusing on differences with the first embodiment.

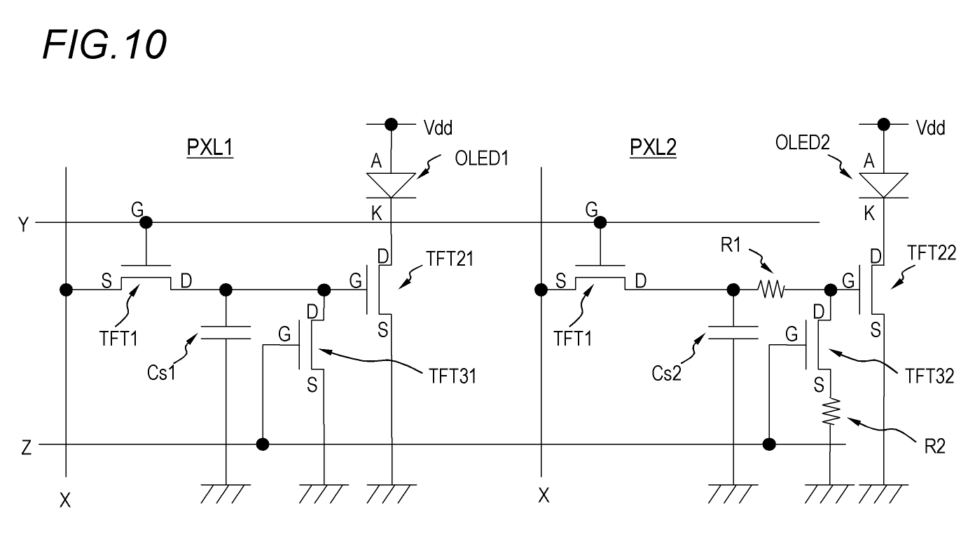

FIG. 10 is an example of an equivalent circuit diagram corresponding to two pixels, namely left and right pixels, according to the third embodiment of the present invention. As shown in the drawing, in the short persistence color pixel circuit PXL2, a resistor R1 is provided between the gate G of the transistor TFT22 that controls the OLED2 and the hold capacitor Cs2. All other configurations are identical to the first embodiment.

The resistor R1 is used to adjust a difference in the rise characteristic of light emission caused by a difference between the persistence characteristics of the light emitters in accordance with a current rise characteristic. A value of R1 should be set such that a time constant constituted by Cs2 and R1 corresponds to the difference between the persistence time constants of the two light emitters.

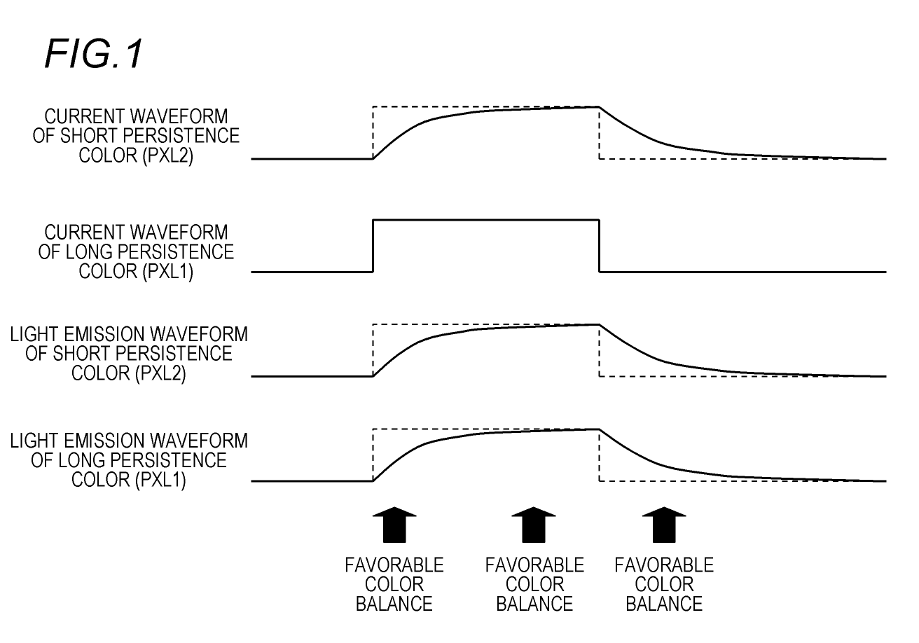

FIG. 1 is a timing chart illustrating an operation of the image display apparatus according to the third embodiment of the present invention, shown in FIG. 10. As shown in the drawing, by adjusting the rise and fall of the current applied to the short persistence color pixel using resistors R1 and R2, the difference between the light emission waveforms of the short persistence color and the long persistence color can be adjusted.

By making the rise speed of the current flowing to the second electro-optic device lower than the rise speed of the current flowing to the first electro-optic device (in other words, by making the rise time of the current flowing to the second electro-optic device longer than the rise time of the current flowing to the first electro-optic device) in this manner, a coloring delay can be suppressed, as shown in FIG. 1. As a result, color balance degradation can be suppressed even more effectively than in the second embodiment.

### Modified Example of Third Embodiment

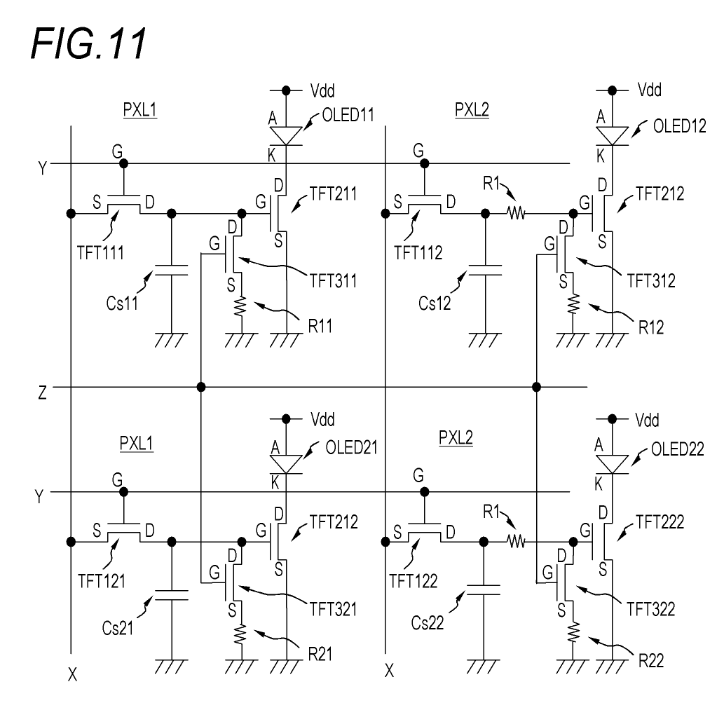

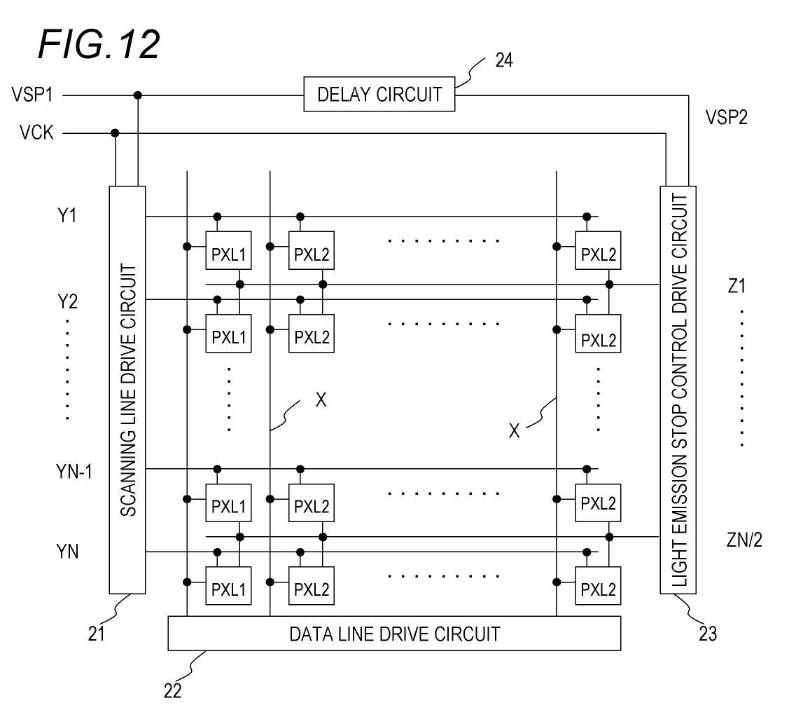

FIG. 11 is an example of a pixel circuit corresponding to four pixels, namely upper, lower, left, and right pixels, according to a modified example of the third embodiment of the present invention. Further, FIG. 12 is an example of a circuit diagram showing an overall configuration of an image display apparatus in which the pixel circuits shown in FIG. 11 are arranged in matrix form. This modified example differs from the third embodiment in that the stop control line Z is shared by the pixel circuits of two vertically adjacent rows, and in characteristics of resistors R11, R12, R21, R22.

The scanning lines Y are separate, and therefore the light emission start timing is later in the lower pixel circuit. The stop control line Z, on the other hand, is shared, and therefore the light emission stop timing is identical in the upper and lower pixel circuits. As a result, the lower pixel circuit has a smaller light emission period (duty), and therefore brightness unevenness occurs. Hence, in this modified example, brightness unevenness is suppressed by reducing the attenuation speed of the current waveform applied to the OLED of the lower pixel circuit relative to that of the upper pixel circuit (in other words, by lengthening a fall time of the current waveform). As a result, an effective light emission period is made identical.

More specifically, setting should be performed such that a time constant constituted by the resistor R21 provided in the extinction circuit of the lower pixel circuit PXL1 and so on is greater than a time constant constituted by the resistor R11 provided in the extinction circuit of the upper pixel circuit PXL1 and so on by approximately a single scanning row period. Further, setting should be performed such that a time constant constituted by the resistor R22 provided in the extinction circuit of the lower pixel circuit PXL2 and so on is greater than a time constant constituted by the resistor R12 provided in the extinction circuit of the upper pixel circuit PXL2 and so on by approximately a single scanning row period. Furthermore, values of the resistors R12 and R11 are set to correspond to the difference between the persistence time constants of the two light emitters (OLED12 and OLED11), similarly to the first embodiment. Values of the resistors R22 and R21 are likewise set to correspond to the difference between the persistence time constants of the two light emitters (OLED22 and OLED21). Note that the value of the resistor R1 is set to be identical to that of the third embodiment.

Thus, brightness unevenness can be prevented from occurring. Moreover, the number of stop control lines Z and the number of output stages of the light emission stop control drive circuit 23 can be halved in comparison with the third embodiment.

### Other

The embodiments described above are merely specific examples of the present invention, and the scope of the present invention is not limited thereto. For example, the circuit configurations described in the respective embodiments are merely examples, and the present invention may be applied to any active-matrix driven self-emitting image display apparatus and includes a plurality of types of electro-optic devices having different persistence characteristics and pixel circuits that output electric signals in order to drive the respective electro-optic devices.

For example, the present invention may be applied to a FED that uses a light emitting element constituted by an electron emission element and a fluorescent substance as the electro-optic device. In a pixel circuit of an FED, the electron emission element is preferably driven by a voltage signal using a source follower circuit. The present invention may also be applied to an image display apparatus having other pixel circuits (various pixel circuits for compensating for TFT characteristic variation and the like). Further, means for suppressing the difference in the light emission characteristic is not limited to a resistor, and the center of gravity of the electric signal waveform (light emission waveform) may be adjusted by modifying the hold capacitor, a gate capacitor, and so on. In so doing, similar effects can be obtained.

In the above embodiments, two types of pixels, namely a long persistence pixel and a short persistence pixel, were described, but the present invention may also be applied to a case in which three of more types of pixels having different persistence characteristics exist. For example, in an RGB three primary color image display apparatus where the persistence times of the respective colors differ by R>G>B, the resistance values added to the pixel circuits of the respective colors may be adjusted such that the centers of gravity of the waveforms of the electric signals applied to the electro-optic devices of the respective colors are delayed in order of R, G, B.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-014412, filed on Jan. 26, 2011, which is hereby incorporated by reference herein in its entirety.

What is claimed is:

1. An active-matrix type self-emitting image display apparatus comprising:
a plurality of scanning lines;
a plurality of data lines; and
a plurality of pixel circuits disposed in respective intersecting portions between the scanning lines and the data lines,
wherein a single pixel is formed from a plurality of pixel circuits including a first pixel circuit that applies an electric signal for driving a first electro-optic device to the first electro-optic device and a second pixel circuit that applies an electric signal for driving a second electro-optic device having a shorter persistence time than the first electro-optic device to the second electro-optic device, and
the first and second pixel circuits output the respective electric signals such that a center of gravity of a waveform of the electric signal applied to the second electro-optic device is temporally delayed relative to a center of gravity of a waveform of the electric signal applied to the first electro-optic device.

2. The image display apparatus according to claim 1, wherein the first and second pixel circuits lengthen a fall time of the waveform of the electric signal applied to the second electro-optic device relative to a fall time of the waveform of the electric signal applied to the first electro-optic device.

3. The image display apparatus according to claim 1, wherein the first and second pixel circuits delay a rise timing of the waveform of the electric signal applied to the second electro-optic device relative to a rise timing of the waveform of the electric signal applied to the first electro-optic device.

4. The image display apparatus according to claim 1, wherein the first and second pixel circuits lengthen a rise time of the waveform of the electric signal applied to the second electro-optic device relative to a rise time of the waveform of the electric signal applied to the first electro-optic device.

5. The image display apparatus according to claim 1, wherein
each of the pixel circuits comprises:
a transistor that controls the electric signal output to the electro-optic device in accordance with a voltage applied to a gate thereof;
a hold capacitor that holds gradation information supplied from the data line and applies a voltage corresponding to the gradation information to the gate of the transistor; and
an extinction circuit that extinguishes the electro-optic device by discharging the hold capacitor, and
the extinction circuit of the second pixel circuit includes a resistor for lowering a discharge speed thereof relative to a discharge speed of the extinction circuit provided in the first pixel circuit.

6. The image display apparatus according to claim 5, wherein the second pixel circuit is connected to a scanning line that is driven immediately after a scanning line to which the first pixel circuit is connected.

7. The image display apparatus according to claim 5, wherein the second pixel circuit includes a resistor between the gate of the transistor and the hold capacitor.

8. A control method for an active-matrix type self-emitting image display apparatus and includes a plurality of pixel circuits disposed in respective intersecting portions between a plurality of scanning lines and a plurality of data lines,
the method comprising the steps of:
applying an electric signal for driving a first electro-optic device to the first electro-optic device from a first pixel circuit; and
applying an electric signal for driving a second electro-optic device having a shorter persistence time than the first electro-optic device to the second electro-optic device from a second pixel circuit that forms a single pixel together with the first pixel circuit,
wherein the first and second pixel circuits output the respective electric signals such that a center of gravity of a waveform of the electric signal applied to the second electro-optic device is temporally delayed relative to a center of gravity of a waveform of the electric signal applied to the first electro-optic device.
